(19) United States
(12) Patent Application Publication
(10) Pub. No.: US 2017/0113369 A1
(43) Pub. Date: Apr. 27, 2017

(54) TOOL MEASUREMENT DEVICE, TOOL MEASUREMENT METHOD AND NON-TRANSITORY COMPUTER READABLE MEDIUM FOR OPERATING TOOL MEASUREMENT METHOD

(71) Applicant: INSTITUTE FOR INFORMATION INDUSTRY, TAIPEI (TW)

(72) Inventors: Hung-Sheng CHIU, Taipei City (TW); Yu-Chi LIU, Taichung City (TW); Ming-Hao HSIAO, Taichung City (TW); Chin-Huang CHANG, Nantou County (TW); Hsiao-Chen CHANG, Taipei City (TW)

(21) Appl. No.: 14/953,031

(22) Filed: Nov. 27, 2015

(30) Foreign Application Priority Data
Oct. 27, 2015 (TW) 104135262

(51) Int. Cl. B26D 5/00; G05B 19/18; B26D 7/24

(52) U.S. Cl. CPC B26D 5/005; B26D 7/24; G05B 19/182; G05B 2219/45044

(57) ABSTRACT

A tool measurement method includes receiving, through a first communication component, at least one first sensing signal from a tool sensor; receiving, through a second communication component, a plurality of coordinates from a machine tool controller; calculating a tool diameter of a cutting tool according to at least first one target coordinate of the coordinates, wherein the at least one first target coordinate corresponds to the first sensing signal; and providing, through the second communication component, the tool diameter of the cutting tool to the machine tool controller.

### RELATED APPLICATIONS

This application claims priority to Taiwan Application Ser. No. 104135262, filed Oct. 27, 2015, which is herein incorporated by reference.

### BACKGROUND

1. Technical Field

The present disclosure relates to a tool measurement device, a tool measurement method, and a non-transitory computer readable medium. More particularly, the present disclosure relates to a tool measurement device, a tool measurement method, and a non-transitory computer readable medium for a cutting tool.

2. Description of Related Art

With advances in technology, machine tools are widely used in industry.

A typical machine tool includes a machine head and a cutting tool. The cutting tool is disposed on the machine head. The machine head is configured to receive control signals from a machine tool controller, and controls the cutting tool to work on a workpiece(e.g., cut the workpiece) according to the control signals.

However, the cutting tool would be worn out after being used for a certain time, and it would decrease the exactitude of the workpiece. Therefore, the cutting tool has to be dismounted and be checked by workman. However, the check for the tool diameter and the tool length of the cutting tool by the workman is limited to personal experience. The process is trivial, complex, and low performance. Also, it would increase the cost of labor and management.

### SUMMARY

One aspect of the present disclosure is related to a tool measurement device. In accordance with one embodiment of the present disclosure, the tool measurement device includes a first communication component, a second communication component, and a processing component. The processing component is configured for receiving, through the first communication component, at least one first sensing signal from a tool sensor; receiving, through the second communication component, a plurality of coordinates from a machine tool controller; calculating a tool diameter of a cutting tool according to at least one first target coordinate of the coordinates, wherein the at least one first target coordinate corresponds to the first sensing signal; and providing, through the second communication component, the tool diameter of the cutting tool to the machine tool controller.

In accordance with one embodiment of the present disclosure, the processing component is further configured for receiving, through the first communication component, at least one second sensing signal from the tool sensor; calculating a tool length of the cutting tool according to at least one second target coordinate of the coordinates, wherein the at least one second target coordinate corresponds to the at least one second sensing signal; and providing, through the second communication component, the tool length of the cutting tool to the machine tool controller.

In accordance with one embodiment of the present disclosure, the processing component is further configured for calculating a tool offset of the cutting tool according to at least one of the tool diameter of the cutting tool and the tool length of the cutting tool; and providing, through the second communication component, the tool offset of the cutting tool to the machine tool controller, so that the machine tool controller adjusts at least one operation of the cutting tool according to the tool offset of the cutting tool.

In accordance with one embodiment of the present disclosure, the processing component is further configured for determining whether the cutting tool is broken according to at least one of the tool diameter of the cutting tool and the tool length of the cutting tool; and providing, through the second communication component, an alarm signal to the machine tool controller under a condition that the cutting tool is broken, so as to make the machine tool controller stop operating the cutting tool.

In accordance with one embodiment of the present disclosure, the processing component is further configured for recording at least one time point of at least one detection of the at least one first sensing signal; and searching at least one of the coordinates corresponding to the at least one time point to serve as the first target coordinate.

In accordance with one embodiment of the present disclosure, the processing component is further configured for loading a computer numerically controlled (CNC) programming to determine whether a tool measurement program of the cutting tool performed by the machine tool controller is started; and starting to detect the at least one first sensing signal and starting to receive the coordinates when the tool measurement program of the cutting tool performed by the machine tool controller is started.

In accordance with one embodiment of the present disclosure, the processing component is further configured for loading a CNC programming to determine whether a tool measurement program of the cutting tool performed by the machine tool controller is terminated; and stopping to detect the at least one first sensing signal and stopping to receive the coordinates when the tool measurement program of the cutting tool performed by the machine tool controller is started.

Another aspect of the present disclosure is related to a tool measurement method. In accordance with one embodiment of the present disclosure, the tool measurement method includes detecting, through a first communication component, at least one first sensing signal from a tool sensor; receiving, through a second communication component, a plurality of coordinates from a machine tool controller; calculating a tool diameter of a cutting tool according to at least first one target coordinate of the coordinates, wherein the at least one first target coordinate corresponds to the first sensing signal; and providing, through the second communication component, the tool diameter of the cutting tool to the machine tool controller.

In accordance with one embodiment of the present disclosure, the tool measurement method further includes receiving, through the first communication component, at least one second sensing signal from the tool sensor; calculating a tool length of the cutting tool according to at least one second target coordinate of the coordinates, wherein the at least one second target coordinate corresponds to the at least one second sensing signal; and providing, through the second communication component, the tool length of the cutting tool to the machine tool controller.

In accordance with one embodiment of the present disclosure, the tool measurement method further includes calculating a tool offset of the cutting tool according to at least one of the tool diameter of the cutting tool and the tool length of the cutting tool; and providing, through the second communication component, the tool offset of the cutting tool to the machine tool controller, so that the machine tool controller adjusts at least one operation of the cutting tool according to the tool offset of the cutting tool.

In accordance with one embodiment of the present disclosure, the tool measurement method further includes determining whether the cutting tool is broken according to at least one of the tool diameter of the cutting tool and the tool length of the cutting tool; and providing, through the second communication component, an alarm signal to the machine tool controller under a condition that the cutting tool is broken, so as to make the machine tool controller stop operating the cutting tool.

In accordance with one embodiment of the present disclosure, the tool measurement method further includes recording at least one time point of at least one detection of the at least one first sensing signal; and searching at least one of the coordinates corresponding to the at least one time point to serve as the first target coordinate.

In accordance with one embodiment of the present disclosure, the tool measurement method further includes loading a CNC programming to determine whether a tool measurement program of the cutting tool performed by the machine tool controller is started; and starting to detect the at least one first sensing signal and starting to receive the coordinates when the tool measurement program of the cutting tool performed by the machine tool controller is started.

In accordance with one embodiment of the present disclosure, the tool measurement method further includes loading a CNC programming to determine whether a tool measurement program of the cutting tool performed by the machine tool controller is terminated; and stopping to detect the at least one first sensing signal and stopping to receive the coordinates when the tool measurement program of the cutting tool performed by the machine tool controller is started.

Another aspect of the present disclosure is related to a non-transitory computer readable medium for storing a computer program configured to execute a tool measurement method. In accordance with one embodiment of the present disclosure, the tool measurement method includes detecting, through a first communication component, at least one first sensing signal from a tool sensor; receiving, through a second communication component, a plurality of coordinates from a machine tool controller; calculating a tool diameter of a cutting tool according to at least first one target coordinate of the coordinates, wherein the at least one first target coordinate corresponds to the first sensing signal; and providing, through the second communication component, the tool diameter of the cutting tool to the machine tool controller.

Through utilizing one embodiment described above, the tool diameter of the cutting tool can be obtained through the tool measurement device.

### BRIEF DESCRIPTION OF THE DRAWINGS

FIG. 1 is a schematic diagram of a tool measurement system according to one embodiment of the present disclosure.

FIG. 2 is illustrates a cutting tool and a tool sensor according to one application of the present disclosure.

FIG. 3 is a flowchart of a tool measurement method according to one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, when an element is referred to as being “connected” or “electrically connected” to another element, it can be directly connected to the other element or intervening elements may be present. In contrast, when an element is referred to as being “directly connected” to another element, there are no intervening elements present. Moreover, “electrically connect” or “connect” can further refer to the interoperation or interaction between two or more elements.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, words indicating direction used in the description of the following embodiments, such as “above,” “below,” “left,” “right,” “front” and “back,” are directions as they relate to the accompanying drawings. Therefore, such words indicating direction are used for illustration and do not limit the present disclosure.

It will be understood that, in the description herein and throughout the claims that follow, unless otherwise defined, all terms (including technical and scientific terms) have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. § 112(f). In particular, the use of “step of” in the claims herein is not intended to invoke the provisions of 35 U.S.C. § 112(f).

One aspect of the present disclosure is related to a tool measurement device. The tool measurement device can communicate with a tool sensor and a tool controller. To facilitate the description to follow, a computer (e.g., a desktop computer or a portable computer) will be taken as examples in the following paragraphs. However, the present disclosure is not limited to this embodiment.

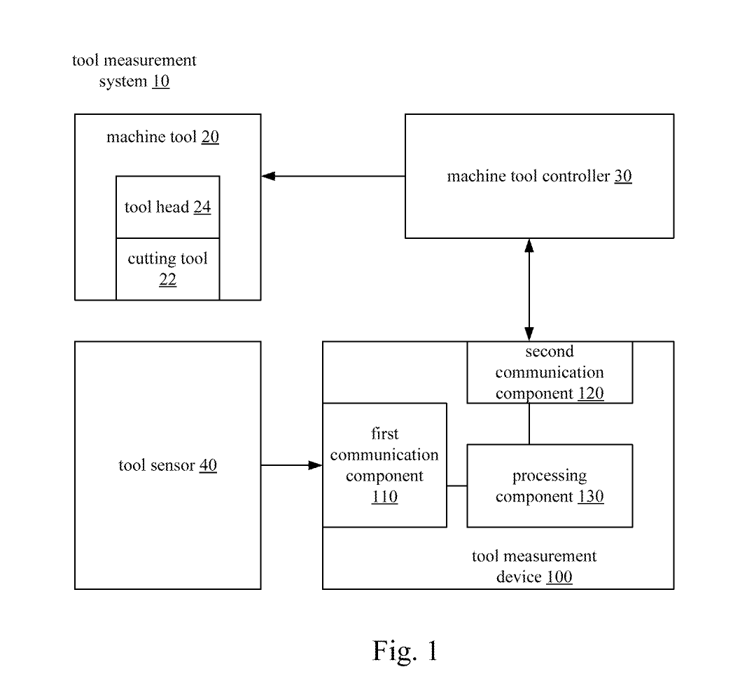

FIG. 1 is a schematic diagram of a tool measurement system 10 according to one embodiment of the present disclosure. In this embodiment, the tool measurement device 10 includes a machine tool 20, a machine tool controller 30, a tool sensor 40, and a tool measurement device 100. In this embodiment, the machine tool controller 30 can be electrically connected to the machine tool 20.

In this embodiment, the tool measurement device 100 can be electrically connected to the machine tool controller 30 and the tool sensor 40. In one embodiment, the tool measurement device 100 can be electrically connected to the tool sensor 40 via a universal serial bus (USB) or an RS-232 connecter. However, another connecting interface is within the contemplate scope of the present disclosure. In one embodiment, the tool measurement device 100 can be electrically connected to the machine tool controller 30 via a USB. However, another connecting interface is within the contemplate scope of the present disclosure.

In one embodiment, the tool measurement device 100 includes a first communication component 110, a second communication component 120, and a processing component 130. In this embodiment, the processing component 130 is electrically connected to the first communication component 110 and the second communication component 120.

In this embodiment, the first communication component 110 may be realized by a communication IC or another component with a communication function. The second communication component 120 may be realized by a communication IC or another component with a communication function. The second communication component 120 can be designed to communicate with various types of the machine tool controller 30. The processing component 130 may be realized by, for example, a central processing unit (CPU), a microprocessor, or another suitable calculating device.

In this embodiment, the machine tool controller 30 is configured to perform a computer numerically controlled (CNC) programming to generate control signals and transmit the control signals to the machine tool 20, so that the machine head 24 is operated according to the control signals CS to perform a tool measurement program of the cutting tool 22. In some embodiments, the related operations of the tool measurement program of the cutting tool 22 can be written into the CNC programming, so that the control signals CS contains signals corresponding to the related operations of the tool measurement program of the cutting tool 22. In some other embodiments, the machine tool controller 30 may be configured to additionally generate control signals corresponding to the measurement of the cutting tool 22 and added it after the control signals CS corresponding to a working procedure (e.g., cutting procedure), so that the tool measurement program of the cutting tool 22 can be performed. In the tool measurement program, the machine tool controller 30 may sequentially generate a plurality coordinates CR corresponding to the position of the cutting tool 22 (or the tool head 24), in which the coordinates CR is relative to a predetermined original point. The second communication component 120 is configured to receive the coordinates CR and provide the coordinates CR to the processing component 130 with a format that can be accessed by the processing component 130.

In addition, in the tool measurement program, the tool sensor 40 is configured to generate at least one first sensing signal SE1 corresponding to the measurement of the tool diameter of the cutting tool 22, and/or at least one second sensing signal SE2 corresponding to the measurement of the tool length of the cutting tool 22. The first communication component 110 is configured to receive the first sensing signal SE1 and/or the second sensing signal SE2 and provide the first sensing signal SE1 and/or the second sensing signal SE2 to the processing component 130 with a format that can be accessed by the processing component 130.

The processing component 130 is configured to calculate the tool diameter of the cutting tool 22 according to at least one first target coordinate of the coordinates CR corresponding to the at least one first sensing signal SE1, and/or calculate the tool length of the cutting tool 22 according to at least one second target coordinate of the coordinates CR corresponding to the at least one second sensing signal SE2. For example, the processing component 130 may calculate the tool diameter of the cutting tool 22 according to two first target coordinates and/or calculate the tool length according to one second target coordinate. Details of such an example will be described in the paragraphs below. Subsequently, the processing component 130 may provide the measured tool diameter and/or the measured tool length to the machine tool controller 30 with a format which can be accessed by the machine tool controller 30 through the second communication component 120, so that the machine tool controller 30 can perform subsequent operations based on the measured tool diameter and/or the measured tool length. In one embodiment, the machine tool controller 30 can calculate a tool offset of the cutting tool 22 according to at least one of the measured tool diameter and the measured tool length.

In a various embodiment, the processing component 130 of the tool measurement device 100 can calculate the tool offset of the cutting tool 22 according to at least one of the measured tool diameter and the measured tool length. Subsequently, the processing component 130 of the tool measurement device 100 can provide the tool offset of the cutting tool 22 to the machine tool controller 30 through the second communication component 120, so that the machine tool controller 30 can adjust at least one subsequent operation based on the tool offset of the cutting tool 22.

That is, in different embodiments, the tool measurement device 100 may provide at least one of the measured tool diameter and the measured tool length to the machine tool controller 30 to make the machine tool controller 30 to calculate the tool offset by itself, and/or provide the tool offset to the machine tool controller 30 to make the machine tool controller 30 adjust at least one subsequent operation based on the tool offset of the cutting tool 22.

In one embodiment, the tool offset can be calculated according to a difference between the measured tool diameter and a standard tool diameter, and/or according to a difference between the measured tool length and a standard tool length. In such a manner, the machine tool controller 30 can adjust at least one subsequent operation based on the tool offset of the cutting tool 22.

Through the operations mentioned above, the measured tool diameter and/or the tool offset of the cutting tool 22 can be obtained through the tool measurement device 100.

In some approaches, a tool sensor is directly connected to a fast I/O interface of a machine tool controller, and directly provides a first sensing signal and a second sensing signal to the machine tool controller. In such a configuration, a developer have to develop different CNC programming for measuring the tool length and/or the tool diameter according to different specifications to conform to different types of machine tool controllers.

In contrast, in some embodiments of the present disclosure, the tool measurement device 100 is used to receive the coordinates CR, the first sensing signal SE1 and/or the second sensing signal SE2, and accordingly calculate the measured tool diameter and/or the measured tool length of the cutting tool 22. The tool measurement device 100 is designed to communicate with various types of the machine tool controller 30. In such a configuration, even different types of the machine tool controllers are used, a developer can develop a program for measuring tool length and/or tool diameter merely on the tool measurement device 100, instead of developing different CNC programming according to different specifications.

In addition, in the embodiment of the present disclosure, using the fast I/O interface (not shown) of the machine tool controller 30 to connect the tool sensor 40 can be avoided, so that the occupation of the resource of the machine tool controller 30 can be decreased.

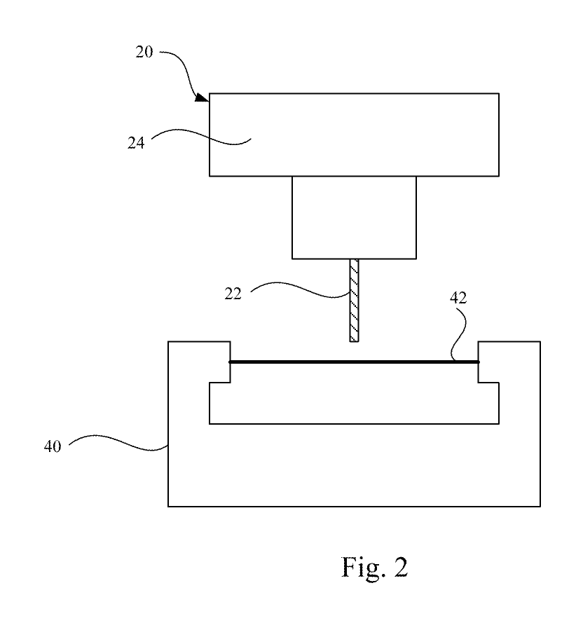

Reference is made to FIG. 2. In one embodiment, the tool sensor 40 may be a laser sensor. In this embodiment, the tool sensor 40 can generate a laser 42. When the laser 42 is shielded by the cutting tool 22, the tool sensor 40 provides the first sensing signal SE1 or the second sensing signal SE2 to the tool measurement device 100. In such a manner, the processing component 130 of the tool measurement device 100 can acquire the first target coordinate corresponding to the first sensing signal SE1 and the second target coordinate corresponding to the second sensing signal SE2 from the coordinates CR.

For example, in one embodiment, the machine tool controller 30 can control the machine tool 20 to horizontally move the cutting tool 22. When one side of the cutting tool 22 shields the laser 42, the tool sensor 40 provides a first sensing signal SE1 to the tool measurement device 100. When the cutting tool 22 stops shielding the laser 42 (when another side of the cutting tool 22 leaves from the laser 42), the tool sensor 40 provides another first sensing signal SE1 to the tool measurement device 100. The processing component 130 of the tool measurement device 100 acquires two first target coordinates from the coordinates CR according to these two first sensing signals SE1, and calculate the measured tool diameter of the cutting tool 22 according to these two first target coordinates.

In one embodiment, the processing component 130 of the tool measurement device 100 records two time points of two detections of the two first sensing signals SE1, and determines two of the coordinates CR corresponding to the two time points to serve as the two first target coordinates.

In one embodiment, when the processing component 130 of the tool measurement device 100 receives each of the coordinates CR from the machine tool controller 30, the processing component 130 can give time stamps to each of the coordinates CR respectively, so that the processing component 130 can find the corresponding coordinates closing to the two time points to serve as the two first target coordinates.

In another embodiment, the machine tool controller 30 can control the machine tool 20 to make the bottom side of the cutting tool 22 (opposite to the top side of the cutting tool 22 connecting to the machine head 24) shields the laser. When the bottom side of the cutting tool 22 shields the laser 42, the tool sensor 40 provides a second sensing signal SE2 to the tool measurement device 100. The processing component 130 of the tool measurement device 100 acquires a second target coordinate from the coordinates CR according to the second sensing signals SE2, and calculates the measured tool length of the cutting tool 22 according to the second target coordinate and a pre-stored reference point. The pre-stored reference point can be acquired by, for example, measuring a standard bar with a known length.

In one embodiment, the processing component 130 of the tool measurement device 100 records a time point of a detection of the second sensing signal SE2, and determines one of the coordinates CR corresponding to the time point to serve as the second target coordinate.

In one embodiment, when the processing component 130 of the tool measurement device 100 receives each of the coordinates CR from the machine tool controller 30, the processing component 130 can give time stamps to each of the coordinates CR respectively, so that the processing component 130 can find the corresponding coordinate closing to the time point to serve as the second target coordinate.

It should be noted that, in some embodiments, the tool sensor 40 can be a machine tool probe. Various of the tool sensors 40 are within the contemplate scope of the present disclosure.

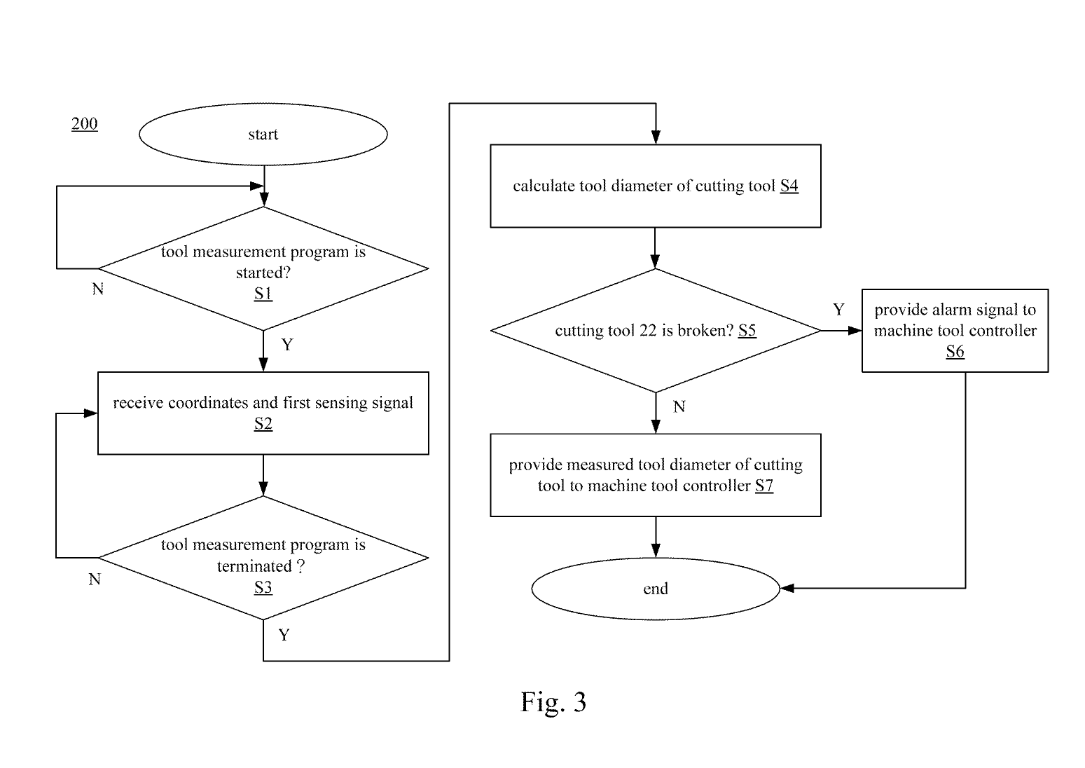

In the following paragraphs, details of the present disclosure are provided with reference to a tool measurement method 200 shown in FIG. 3. However, the present disclosure is not limited to the embodiment below.

It should be noted that, the tool measurement method 200 can be applied to a tool measurement device having a structure that is the same as or similar to the structure shown in FIG. 1. To simplify the description below, in the following paragraphs, the embodiment shown in FIG. 1 will be used as an example to describe the tool measurement method 200 according to an embodiment of the present disclosure. However, the present disclosure is not limited to application to the embodiment shown in FIG. 1.

Additionally, the tool measurement method 200 can be implemented as a computer program stored in a non-transitory computer readable medium to be read for controlling a computer or an electronic device to execute the tool measurement method 200. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this disclosure pertains.

In addition, it should be noted that, in the steps of the following tool measurement method 200, no particular sequence is required unless otherwise specified. Moreover, the following steps also may be performed simultaneously or the execution times thereof may at least partially overlap.

Furthermore, the steps of the following tool measurement method 200 may be added, replaced, and/or eliminated as appropriate, in accordance with various embodiments of the present disclosure.

In this embodiment, the tool measurement method 200 includes the steps below.

In step S1, the processing component 130 of the tool measurement device 100 loads a CNC programming of the machine tool controller 30 to determine whether a tool measurement program of the cutting tool 22 performed by the machine tool controller 30 is started. If so, step S2 is performed. If not, step S1 is continuously performed.

In step S2, after the machine tool controller 30 starts to perform the tool measurement program of the cutting tool 22, the processing component 130 of the tool measurement device 100 starts to sequentially receive a plurality of coordinates CR from the machine tool controller 30 through the second communication component 120 and receive at least one first sensing signal SE1 from the tool sensor 40 through the first communication component 110.

In step S3, the processing component 130 of the tool measurement device 100 loads the CNC programming of the machine tool controller 30 to determine whether the tool measurement program of the cutting tool 22 performed by the machine tool controller 30 is terminated. If so, step S4 is performed. If not, the procedure returns to step S2.

In one embodiment, after the tool measurement program of the cutting tool 22 performed by the machine tool controller 30 is terminated, the processing component 130 of the tool measurement device 100 stops detecting the at least one first sensing signal SE1 and stops receiving the coordinates CR.

In step S4, the processing component 130 of the tool measurement device 100 calculates a tool diameter of the cutting tool 22 according to at least one first target coordinate of the coordinates CR, in which the at least one first target coordinate corresponds to the first sensing signal SE1. Details of the first target coordinate and the calculation of the tool diameter of the cutting tool 22 can be ascertained with reference to the paragraphs above, and a description in this regard will not be repeated herein.

In step S5, the processing component 130 of the tool measurement device 100 determines whether the cutting tool 22 is broken according to the tool diameter of the cutting tool 22. If so, step S6 is performed. If not step S7 is performed.

In one embodiment, the processing component 130 of the tool measurement device 100 determines whether the cutting tool 22 is broken by determining whether the tool diameter of the cutting tool 22 is less than a predetermined threshold.

In step S6, under a condition that the cutting tool 22 is broken, the processing component 130 of the tool measurement device 100 provides an alarm signal to the machine tool controller 30 through the second communication component 120, so as to make the machine tool controller 30 stop to operate the cutting tool 22.

In step S7, under a condition that the cutting tool 22 is not broken, the processing component 130 of the tool measurement device 100 provides the measured tool diameter of the cutting tool 22 to the machine tool controller 30 through the second communication component 120, so as to make the machine tool controller 30 accordingly perform subsequent operations.

Through utilizing one embodiment described above, the tool diameter of the cutting tool 22 can be obtained through the tool measurement device 100.

In one embodiment, in step S2, the processing component 130 of the tool measurement device 100 can further receive at least one second sensing signal SE2 from the tool sensor 40 through the first communication component 110. In this embodiment, in step S4, the processing component 130 of the tool measurement device 100 can further calculate the tool length of the cutting tool 22 according to a second target coordinate of the coordinates CR corresponding to the second sensing signal SE2. In this embodiment, in step S5, the processing component 130 of the tool measurement device 100 can determine whether the cutting tool 22 is broken according to at least one of the tool diameter and the tool length of the cutting tool 22. Additionally, in this embodiment, in step S7, the processing component 130 of the tool measurement device 100 can further provide the measured tool length of the cutting tool 22 to the machine tool controller 30 through the second communication component 120, so as to make the machine tool controller 30 accordingly perform subsequent operations.

Although the present disclosure has been described in considerable detail with reference to certain embodiments thereof, other embodiments are possible. Therefore, the scope of the appended claims should not be limited to the description of the embodiments contained herein.

What is claimed is:

1. A tool measurement device comprising:
a first communication component;
a second communication component; and
a processing component configured for:
receiving, through the first communication component, at least one first sensing signal from a tool sensor;
receiving, through the second communication component, a plurality of coordinates from a machine tool controller;
calculating a tool diameter of a cutting tool according to at least one first target coordinate of the coordinates, wherein the at least one first target coordinate corresponds to the first sensing signal; and
providing, through the second communication component, the tool diameter of the cutting tool to the machine tool controller.

2. The tool measurement device as claimed in claim 1, wherein the processing component is further configured for:
receiving, through the first communication component, at least one second sensing signal from the tool sensor;
calculating a tool length of the cutting tool according to at least one second target coordinate of the coordinates, wherein the at least one second target coordinate corresponds to the at least one second sensing signal; and
providing, through the second communication component, the tool length of the cutting tool to the machine tool controller.

3. The tool measurement device as claimed in claim 2, wherein the processing component is further configured for:
calculating a tool offset of the cutting tool according to at least one of the tool diameter of the cutting tool and the tool length of the cutting tool; and
providing, through the second communication component, the tool offset of the cutting tool to the machine tool controller, so that the machine tool controller adjusts at least one operation of the cutting tool according to the tool offset of the cutting tool.

4. The tool measurement device as claimed in claim 2, wherein the processing component is further configured for:
determining whether the cutting tool is broken according to at least one of the tool diameter of the cutting tool and the tool length of the cutting tool; and
providing, through the second communication component, an alarm signal to the machine tool controller under a condition that the cutting tool is broken, so as to make the machine tool controller stop operating the cutting tool.

5. The tool measurement device as claimed in claim 1, wherein the processing component is further configured for:
recording at least one time point of at least one detection of the at least one first sensing signal; and
searching at least one of the coordinates corresponding to the at least one time point to serve as the first target coordinate.

6. The tool measurement device as claimed in claim 1, wherein the processing component is further configured for:
loading a computer numerically controlled (CNC) programming to determine whether a tool measurement program of the cutting tool performed by the machine tool controller is started; and
starting to detect the at least one first sensing signal and starting to receive the coordinates when the tool measurement program of the cutting tool performed by the machine tool controller is started.

7. The tool measurement device as claimed in claim 1, wherein the processing component is further configured for:
loading a computer numerically controlled (CNC) programming to determine whether a tool measurement program of the cutting tool performed by the machine tool controller is terminated; and
stopping to detect the at least one first sensing signal and stopping to receive the coordinates when the tool measurement program of the cutting tool performed by the machine tool controller is started.

8. A tool measurement method comprising:
detecting, through a first communication component, at least one first sensing signal from a tool sensor;
receiving, through a second communication component, a plurality of coordinates from a machine tool controller;
calculating a tool diameter of a cutting tool according to at least first one target coordinate of the coordinates, wherein the at least one first target coordinate corresponds to the first sensing signal; and
providing, through the second communication component, the tool diameter of the cutting tool to the machine tool controller.

9. The tool measurement method as claimed in claim 8 further comprising:
receiving, through the first communication component, at least one second sensing signal from the tool sensor;
calculating a tool length of the cutting tool according to at least one second target coordinate of the coordinates, wherein the at least one second target coordinate corresponds to the at least one second sensing signal; and
providing, through the second communication component, the tool length of the cutting tool to the machine tool controller.

10. The tool measurement method as claimed in claim 9 further comprising:
calculating a tool offset of the cutting tool according to at least one of the tool diameter of the cutting tool and the tool length of the cutting tool; and
providing, through the second communication component, the tool offset of the cutting tool to the machine tool controller, so that the machine tool controller adjusts at least one operation of the cutting tool according to the tool offset of the cutting tool.

11. The tool measurement method as claimed in claim 9 further comprising:
determining whether the cutting tool is broken according to at least one of the tool diameter of the cutting tool and the tool length of the cutting tool; and
providing, through the second communication component, an alarm signal to the machine tool controller under a condition that the cutting tool is broken, so as to make the machine tool controller stop operating the cutting tool.

12. The tool measurement method as claimed in claim 8 further comprising:
at least one time point of at least one detection of the at least one first sensing signal; and
searching at least one of the coordinates corresponding to the at least one time point to serve as the first target coordinate.

13. The tool measurement method as claimed in claim 8 further comprising:
loading a computer numerically controlled (CNC) programming to determine whether a tool measurement program of the cutting tool performed by the machine tool controller is started; and
starting to detect the at least one first sensing signal and starting to receive the coordinates when the tool measurement program of the cutting tool performed by the machine tool controller is started.

14. The tool measurement method as claimed in claim 8 further comprising:
loading a computer numerically controlled (CNC) programming to determine whether a tool measurement program of the cutting tool performed by the machine tool controller is terminated; and
stopping to detect the at least one first sensing signal and stopping to receive the coordinates when the tool measurement program of the cutting tool performed by the machine tool controller is started.

15. A non-transitory computer readable medium for storing a computer program configured to execute a tool measurement method, the tool measurement method comprising:
detecting, through a first communication component, at least one first sensing signal from a tool sensor;
receiving, through a second communication component, a plurality of coordinates from a machine tool controller;
calculating a tool diameter of a cutting tool according to at least first one target coordinate of the coordinates, wherein the at least one first target coordinate corresponds to the first sensing signal; and
providing, through the second communication component, the tool diameter of the cutting tool to the machine tool controller.
